(19) United States
(12) Patent Application Publication
(10) Pub. No.: US 2013/0318758 A1
(43) Pub. Date: Dec. 5, 2013

(54) VIAL CAP TOOL

(71) Applicant: Amy Thrash, Spring Hill, TN (US)

(72) Inventor: Amy Thrash, Spring Hill, TN (US)

(21) Appl. No.: 13/804,160

(22) Filed: Mar. 14, 2013

Related U.S. Application Data
(60) Provisional application No. 61/655,734, filed on Jun. 5, 2012.

(51) Int. Cl. B25B 27/00

(52) U.S. Cl. CPC B25B 27/0028
USPC 29/235

(57) ABSTRACT

A hand-held apparatus is provided to allow a user to easily apply the necessary force required to install or remove caps into or from a vial or test tube. The device includes a handle member that is ergonomically shaped to provide a user with maximum comfort and control of a cap while applying pressure to insert caps. The device also includes a coupling portion configured to selectively engage a cap and efficiently disengage a cap. Through this configuration, a user generated force is transferred from the handle member through the coupling portion, and to the cap, thereby causing the cap into an opening of the vial for locking the cap into a sealed and closed position with the vial.

### CROSS REFERENCE TO RELATED APPLICATION

This application claims the benefit of U.S. Provisional Application No. 61/655,734, filed on Jun. 5, 2012 which is hereby incorporated herein by reference.

### TECHNICAL FIELD

This disclosure relates generally to a device for installing and removing caps on vials and test tubes, and more particularly to an ergonomic apparatus that enables quick and easy installation and removal of the caps.

### BACKGROUND

The statements in this section merely provide background information related to the present disclosure and may not constitute prior art.

Test tubes are extensively used in laboratories and research facilities worldwide for containing liquids and mixtures during experiments and research-based pursuits. Often it is necessary to seal, mix, and/or transport contained substances within the test tube creating the need for test tube caps that couple to the opening of the test tube, thereby holding in the contained substance. Advances in polymer science have led to the creation of plastic polypropylene test tubes and test tube caps that are disposable. These plastic polypropylene test tubes and test tube caps are inexpensive and do not shatter when dropped, however glass embodiments are known to break when dropped.

A wide range of test tubes are available in different sizes and colors, including a 12×75 mm standard sized test tube which is used by many organizations. Various capping structures are used to create a seal between the cap and the test tube. One commonly used capping structure is the flange cap, which consists of two flanges that extend around the outer periphery of the bottom portion of the cap that is inserted into the opening on the top of the test tube. The cap is snapped into a sealed position within the aperture of the test tube, so that a flange that extends from the inner surface of the test tube is pushed between the two flanges extending out from the capping structure.

Laboratories and research facilities often generate large numbers of test tubes daily that must be sealed with a cap. The task of a person sealing test tubes with various types of caps, and in particular flange caps, is time consuming and requires a repeated movement of the hands in the same manner and position. As a result, the task of repeatedly capping test tubes can cause uncomfortable inflammation or other similar illnesses and injuries. In addition to causing pain and discomfort to the user, the disease also can lead to a decrease in employee productivity levels.

The prior art details a device that seeks to provide means for attaching and detaching caps onto test tubes in USPN 2010/0088871. However, the device utilizes a projecting member that protrudes from the device to engage the cap. The projecting member applies user force unevenly upon a cap and requires that the projecting member be placed centrally to a recess of a cap. Uneven force can leave caps not fully coupled to a vial or, worse, tip, spill or damage vials by applying unintended, angled force with respect to a vial. Further the projecting member is awkward or slow to disengage from the cap as frictional forces or engagement compression forces undesirably engage portions of the cap, inhibiting production capacity. In use, the prior art device generally requires two hands for operation, one to hold the tool and a second to balance the test tube. Additional disadvantages include inapplicability to multiple vial cap types. For example, the prior art device performs poorly when used with vial caps having no recess.

Therefore, there exists a need to for an apparatus to assist a user to apply and disengage caps to vials with greater control without decreasing comfort.

### SUMMARY

A hand-held apparatus is provided to allow a user to easily apply the necessary force required to install caps into a vial or test tube. The device includes a handle member that is ergonomically shaped to provide a user with maximum comfort and control of a cap while applying pressure to insert caps. The device also includes a coupling portion configured to selectively engage a cap and efficiently disengage a cap. Through this configuration, a user generated force is transferred from the handle member through the coupling portion, and to the cap, thereby causing the cap into an opening of the vial for locking the cap into a sealed and closed position with the vial.

Additional embodiments of the present disclosure include a de-coupling tool configured to selectively disengage a cap from a test tube. Through this configuration, a user generated force is transferred from the handle member through the de-coupling portion and to the cap, in the form of a lever machine, thereby causing the cap to disengage from an opening of the vial.

Additional embodiments of the present disclosure include a handle portion selectively attachable to a coupling tool or a de-coupling tool.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 is a perspective view showing an exemplary test tube and cap, in accordance with an embodiment of the present disclosure;

FIG. 2 is a perspective view of a hand-held apparatus, in accordance with an embodiment of the present disclosure;

FIG. 3 is a side view of the hand-held apparatus, in accordance with an embodiment of the present disclosure;

FIG. 4 is a top view of the hand-held apparatus, in accordance with an embodiment of the present disclosure;

FIG. 5 is a top perspective view of the hand-held apparatus, in accordance with an embodiment of the present disclosure;

FIG. 6 is a cross-sectional view of the hand-held apparatus along line A-A as shown in FIG. 4, in accordance with an embodiment of the present disclosure;

FIGS. 7-8 show an embodiment of the hand-held apparatus having a selectively severable body, in accordance with an embodiment of the present disclosure;

FIGS. 9-12 show an embodiment of a coupling portion configured to selectively couple to the severable body shown in FIGS. 7 and 8, in accordance with an embodiment of the present disclosure;

FIGS. 13-16 show a second embodiment of a coupling portion configured to selectively couple to the severable body shown in FIGS. 7 and 8, in accordance with an embodiment of the present disclosure; and

FIGS. 17-21 show a de-coupling attachment tool configured to selectively couple to the severable body shown in FIGS. 7 and 8, in accordance with an embodiment of the present disclosure.

### DETAILED DESCRIPTION

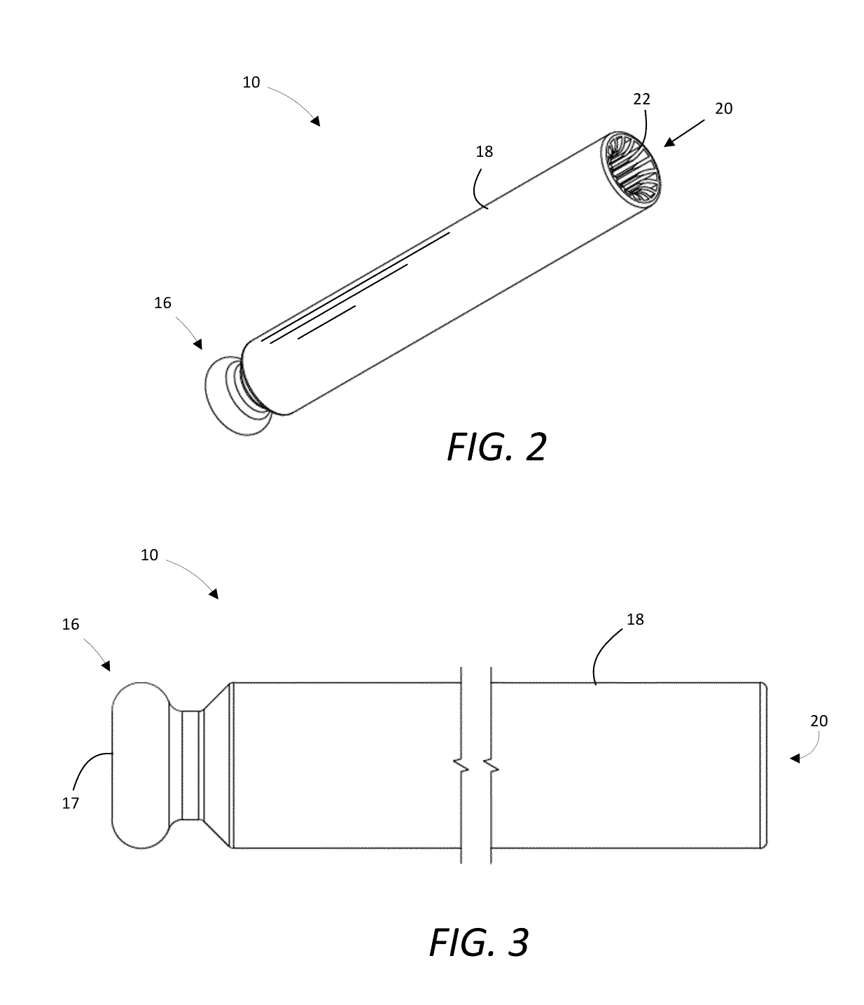

Referring now to the drawings, wherein the depictions are for the purpose of illustrating certain exemplary embodiments only and not for the purpose of limiting the same, FIG. 2 shows an exemplary cap 12 insertable within the vial or test tube 14. As FIG. 2 shows, the test tube 14 is formed of a cylindrical-shaped body that may be a transparent glass or plastic structure. The cap 12 may be any known type configured to seal or close an opening of the test tube 14. The cap 12 may be formed of or include any known substance such as rubber or plastic polymer. In one embodiment, the outer surface of the test tube 14 is configured to receive visual indicia such as a description or scannable code. The teachings of the disclosure herein may readily be applied to various types of test tubes and caps and therefore is not intended to be limited thereby.

FIG. 2 shows a hand-held apparatus 10 for installing the cap 12 on the test tube 14 according to an embodiment of the present invention. The apparatus 10 includes a top portion 16, a cylindrical-shaped body 18, and a coupling portion 20. The cylindrical-shaped body 18 is intended to ergonomically receive a user's palm and fingers when gripped in use. The coupling portion 20 is configured to engage the cap 12 around an outer periphery.

The apparatus 10 is formed of any suitable compliant material that is sufficiently rigid to adequately transfer forces generated by the user, while still being compliant enough to provide comfort and minimize uncomfortable inflammation. Some examples of such material include a polyurethane foam rubber, various metals, a contained gel, or polymer-based. The apparatus 10 is preferably integrally formed into a contiguous structure; however it is contemplated by the disclosure herein that portions of the apparatus may be separately coupled together such as the top portion 16 and the body 18 and/or the coupling portion 20 and the body 18. In one embodiment, portions of the apparatus 10 may be hollow. In a further embodiment, the apparatus 10 is formed of sufficiently rigid material to transfer the user applied force from the apparatus 10 to the cap 12, to secure the cap 12 to the test tube 14 without causing any damage to the cap 12.

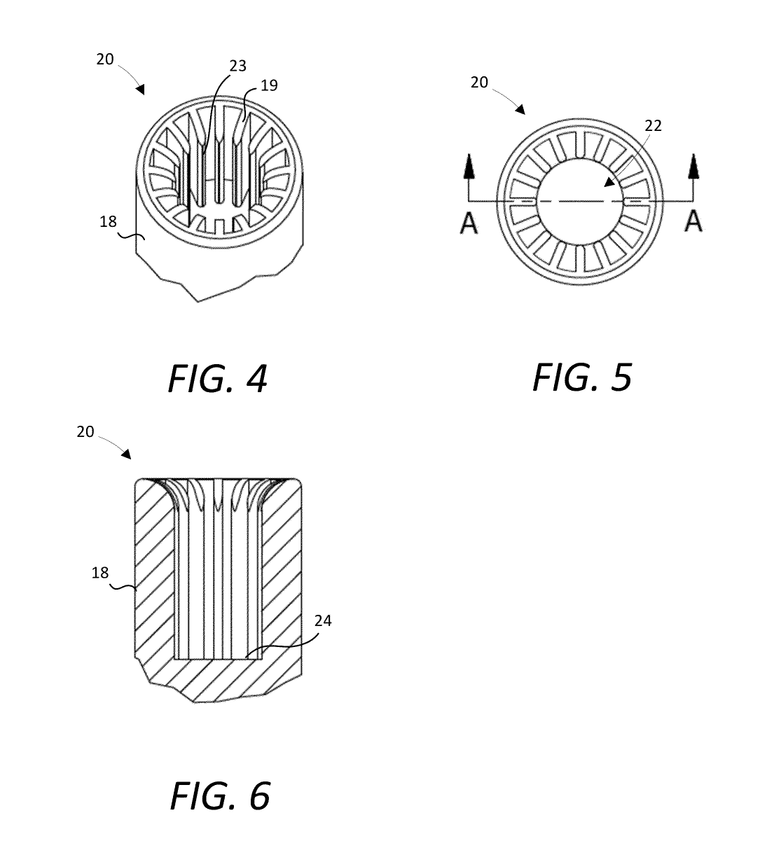

FIG. 3 shows a side view of the apparatus 10. As FIG. 3 shows, the top portion 16 is vase-shaped, although the top portion 16 may be shaped in any number of configurations including flush with the body 18. In one embodiment, a top surface 17 of the top portion is slightly recessed to ergonomically receive a user's thumb. In this way, pressure and force from a user is more efficiently transferred to the cap 12 via the apparatus 10.

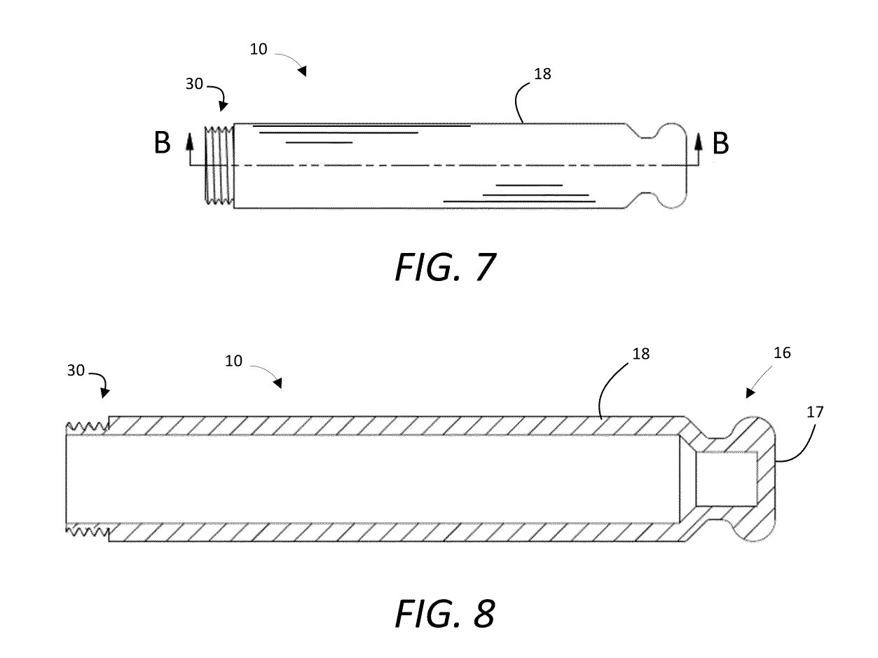

FIG. 4 shows a top view of the apparatus 10 and coupling portion 20 including a cavity 22 and a plurality of flanges 19. The flanges 19 are preferably longitudinal arranged and radially extended and spaced toward a center region of the cavity 22. In one embodiment, however, the flanges 19 are flexible and configured to moveably engage a cap. The flanges 19 may be integrally formed of the apparatus 10. In one embodiment, the flanges 19 are molded to inner walls of the cavity and configured to flex upon receipt of a cap. The cavity 22 is preferably circular-shaped, but may be sized and adapted to receive a particular size cap 12. For example, a diameter of an outer periphery of the cavity 22 is preferably slightly larger than a diameter of a corresponding cap diameter.

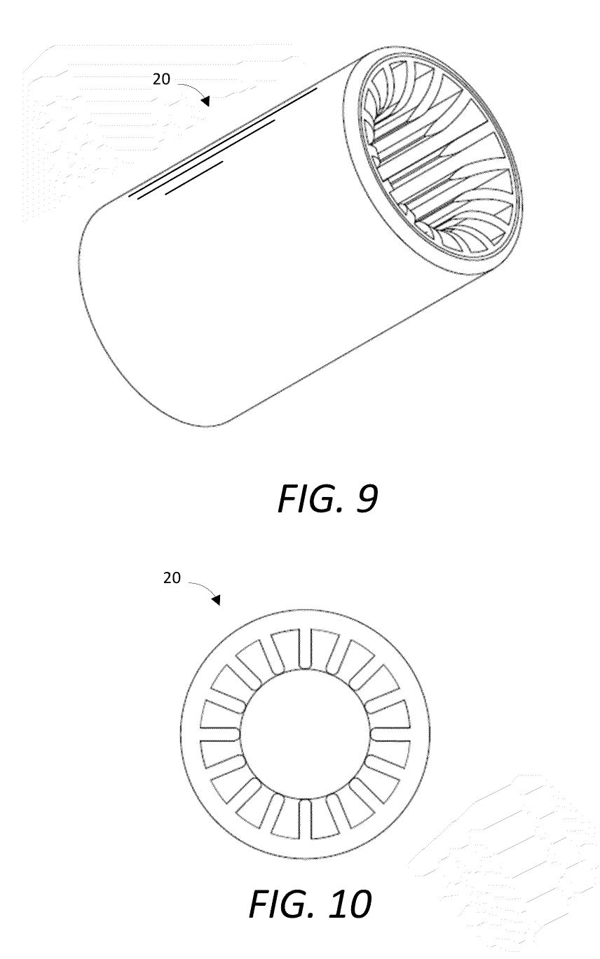

FIG. 5 shows a perspective view of the coupling portion 20 of the apparatus 10. As FIG. 5 shows, the space between the flanges 19 open into the cavity 22. The spaces between the flanges 19 enable a cap to freely exit the cavity 22 without suction forces inhibiting an exit. In one embodiment, the flanges 19 are tapered or pointed at an engagement end. The tapered ends 23 enable decreased frictional forces to be applied to cap sidewall. The decreased frictional forces enable preferable release of caps upon coupling to a test tube, and decrease inhibition of the cap from the coupling portion 20.

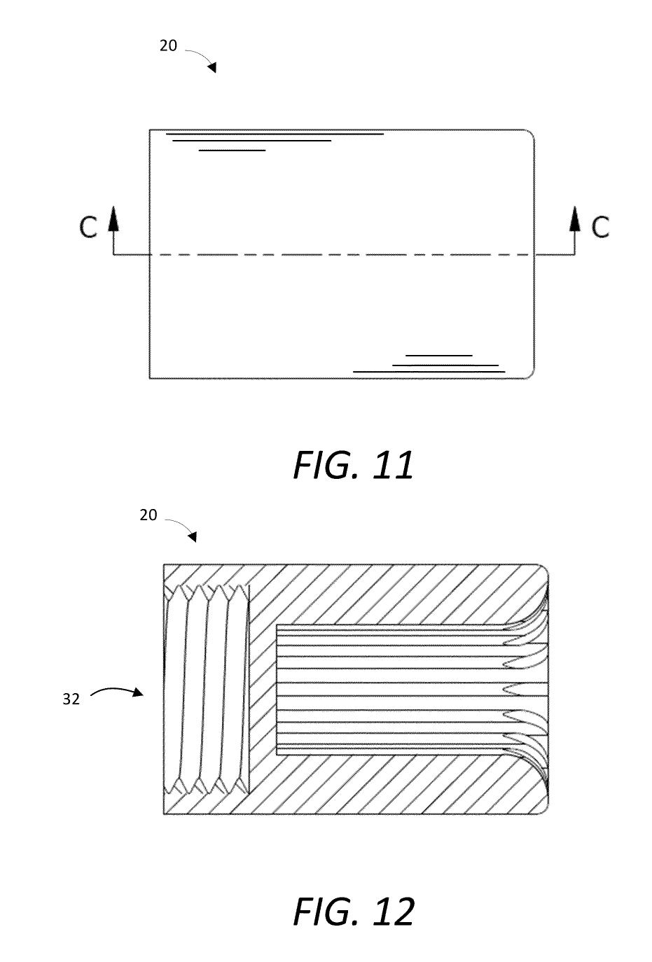

FIG. 6 shows a cross-sectional view of the coupling portion 20 of the apparatus 10 along line A-A as shown in FIG. 5. As FIG. 6 shows, the coupling portion 20 is defined by a bottom wall 24. The bottom wall 24 is preferably substantially flat and configured to engage a top surface of the cap 12. When in engagement with the cap 12, the bottom wall is at least substantially flush against the top surface of the cap 12. In this way, the user generated force applied to the apparatus 10 is adequately distributed to the cap 12 and applied substantially evenly to the cap 12, enabling desirable user control of the force direction. Further, because the flanges 19 engage the cap 12 at points along a cap sidewall, preferable frictional forces are effectively utilized, enabling preferable release of an engaged cap. Accordingly, the coupling portion 20 along with the apparatus 10 can be disengaged quickly and easily from the cap 12, thereby enabling a user to install a plurality of caps in a short period of time.

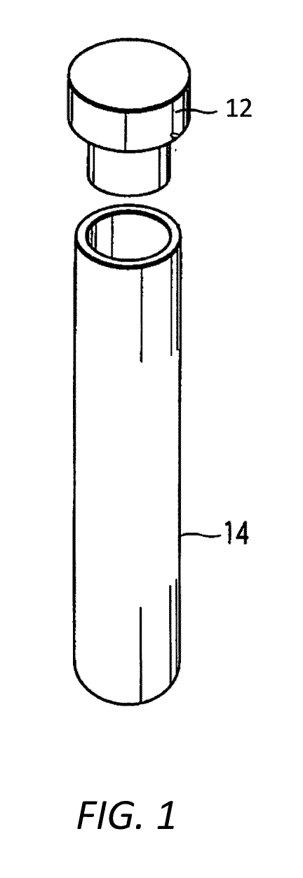

It is contemplated that the disclosure herein can be applied with any type of cap that fits on any standard sized test tube, including but not limited to: 12 mm, 13 mm, 16 mm, and 17 mm diameter test tubes and test tube caps. Such cap types can include but are not limited to screw caps or flange caps. The flange cap 12 may include an upper and/or lower flange, extending outward around the periphery of the lower section of the cap 12. According to an embodiment of the present disclosure, the apparatus 10 is configured for use in installing a cap 12 into a test tube 14 containing an inwardly pointed flange that extends around the inner periphery of the test tube 14. In locking a flange-type cap 12 into a sealed position, the cap 12 is pushed into the opening of the test tube 14 through a downwardly directed force indicated by the arrow shown in FIG. 1. In pushing the cap 12 into the test tube 14, the lower flange is displaced over and beneath the inwardly pointed test tube flange, so that the inwardly pointed flange is positioned between the upper and lower flanges of the cap 12. This in turn secures the cap 12 to the test tube 14 creating a seal about the opening.

According to an exemplary embodiment of the present disclosure, in operation, the apparatus 10 is placed in use by first placing a cap 12 over the opening of the test tube 14. The user then grasps the body 18 of the apparatus 10 and couples the cap 12 into the cavity 22 of the coupling portion 20. Finally, a user generates a force in the direction indicated by the arrow shown in FIG. 1 in relation to the test tube 14 and the cap 12. This force is transferred from the apparatus 10, through the coupling portion 20, and to the cap 12, thereby causing the cap 12 to engage within the opening of the test tube 14 and create a closed and sealed structure.

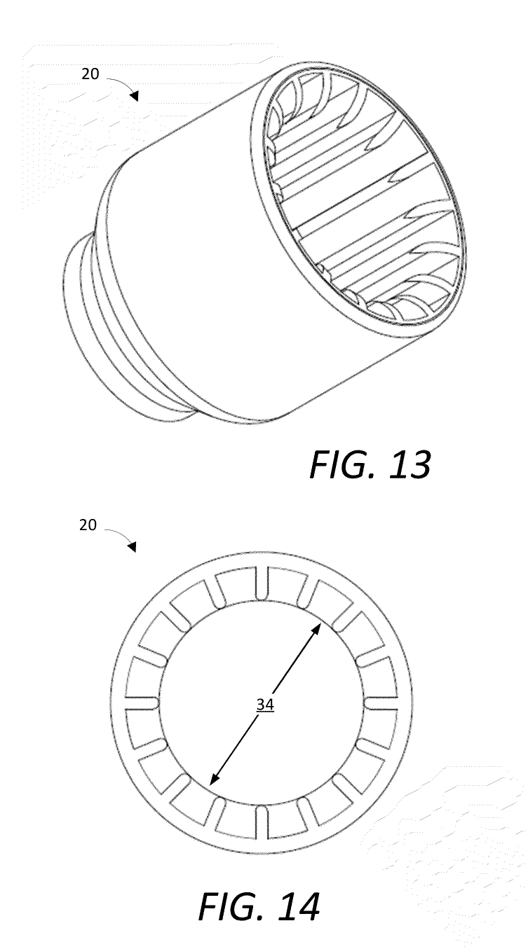

FIGS. 7-8 show an embodiment of the apparatus 10 having a selectively severable body 18 from a tool portion. FIG. 7 shows an embodiment of the apparatus 10 having a severable body 18. As FIG. 7 shows, the severable body 18 may include a coupling means 30. The coupling means 30 may be a mechanical screw. In one embodiment, the coupling means 30 is a screw shaft having an outer surface being formed with a helical male thread and groove, wherein a corresponding coupling tool is formed of a helical female thread and groove. Although it is contemplated herein that the coupling means 30 may be a helical female groove wherein the corresponding tool sets are formed of a helical male groove. The helical male groove is configured to rotatably mate with a helical female groove on a corresponding coupling portion as described herein below.

FIG. 8 shows a cross-sectional view of the severable body 18 of the apparatus 10 along line B-B as shown in FIG. 7. As FIG. 8 shows, the severable body 18 may include a hallow interior in one embodiment. In one embodiment, the severable body 18 is integrally formed into a contiguous structure, and rigidly formed to transfer the user applied force from the severable body 18 to an attached tool or coupling portion. As FIG. 8 shows, the coupling means 30 preferably includes a plurality of helically-shaped threads and grooves on an outer surface configured to couple to an inner surface of a coupling portion, wherein the threads and grooves of the coupling means are sized and adapted to mesh or couple to corresponding threads and grooves of the coupling tool.

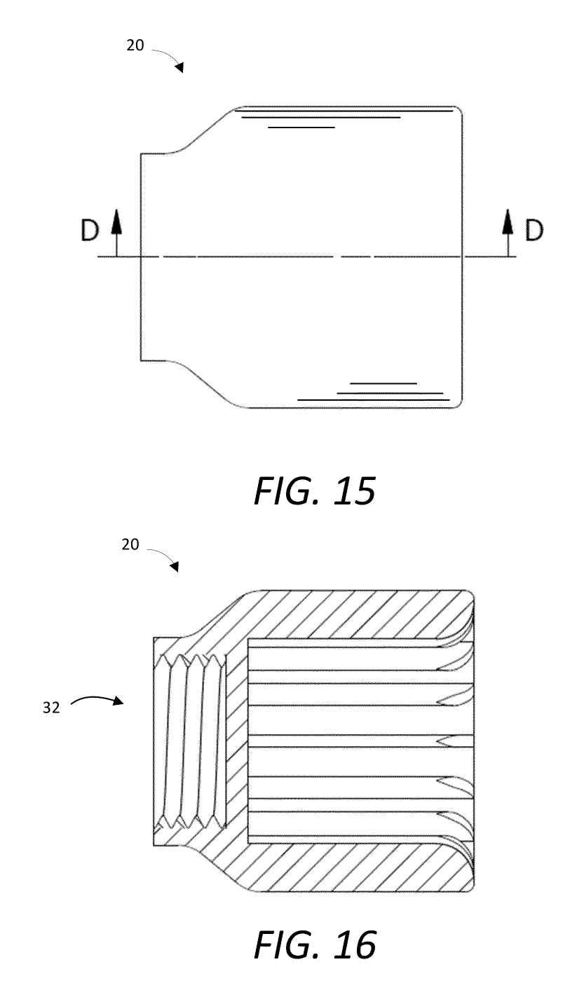

FIGS. 9-12 show an embodiment of a coupling portion 20 configured to selectively couple to the severable body 18 described herein above and shown in FIGS. 7 and 8. As FIGS. 9 and 10 show, the coupling portion 20 is configured to engage a cap of a test tube so that a user may couple the cap to the test tube. As described herein above with respect to FIGS. 3-5, the coupling portion 20 includes a cavity 22 and a plurality of flanges 19. Within the coupling portion 20, the flanges 19 are preferably longitudinal arranged and radially extended and spaced toward a center region of the cavity 22. In one embodiment, however, the flanges 19 are flexible and configured to moveably engage a cap. The flanges 19 may be integrally formed of the coupling portion 20. In one embodiment, the flanges 19 are molded to inner walls of the cavity and configured to flex upon receipt of a cap. The space between the flanges 19 open into the cavity 22 of the coupling portion 20. The cavity 22 is preferably circular-shaped, but may be sized and adapted to receive a particular size cap 12.

FIG. 11 shows a side view of the coupling portion 20. FIG. 12 shows a cross-sectional view of the coupling portion 20 along line C-C as shown in FIG. 11. As FIG. 12 shows, the coupling portion 20 includes a coupling means 32 configured to engage the coupling means 30 of the severable body 18. The coupling means 32 preferably includes helically-shaped threads and grooves on an inner surface configured to couple to an outer surface of a shaft portion such as the severable body 18, wherein the threads and grooves of the coupling means 32 are sized and adapted to mesh or couple to corresponding threads and grooves of the coupling means 30.

According to an exemplary embodiment of the present disclosure, in operation, the coupling portion 20 is coupled to the severable body 18 by rotatably screwing the coupling means 32 over the coupling means 30. During engagement of the coupling portion 20 to the severable body 18, the coupling portion 20 may be rotated relative to the severable body 18, moving the coupling means 32 axially relative to the coupling means 30 of the severable body 18.

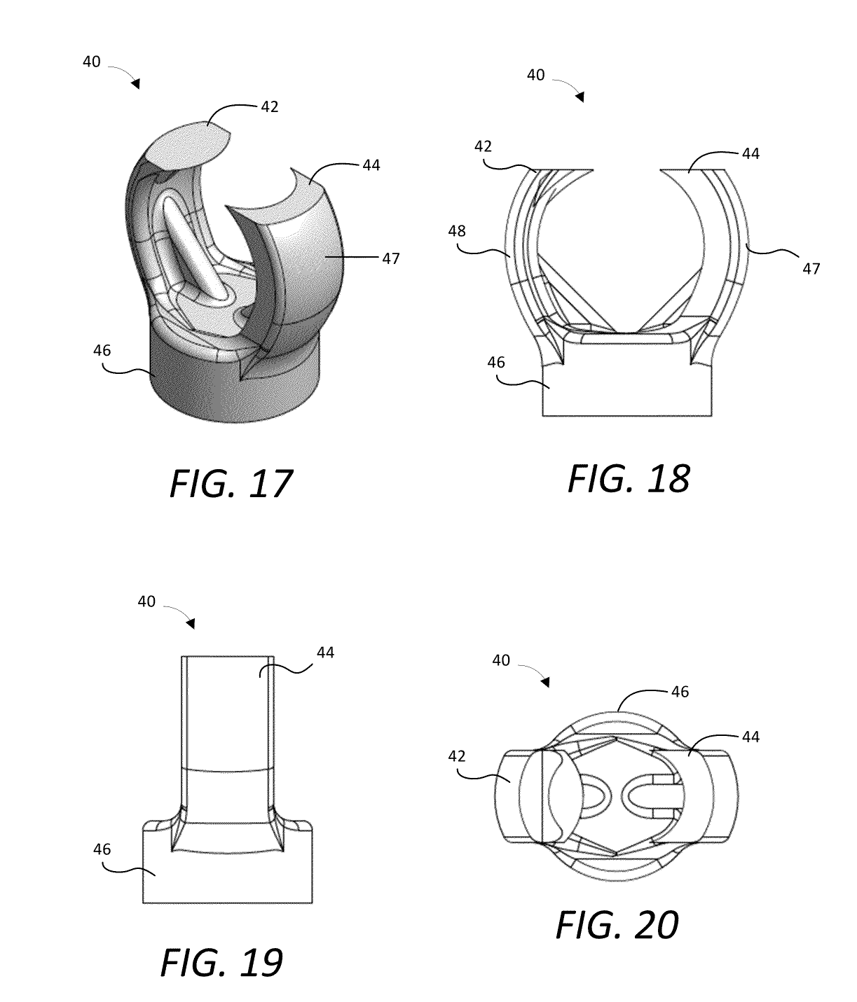

FIGS. 13-16 show a second embodiment of a coupling portion 20 configured to selectively couple to the severable body 18 described herein above and shown in FIGS. 7 and 8. The second embodiment is included herein as exemplary to illustrate and describe a coupling portion 20 configured to engage larger vial caps. Upon a careful reading of the teachings herein, one skilled in the art will readily adapt the teaching to any sized vial or cap size including adapting the coupling portion to engage caps from 8 mm, 12 mm, and 15 mm shell vials.

As FIG. 13 shows, the second embodiment of a coupling portion 20 may be funneled outward to form the cavity 22 with a larger void space. FIG. 14 shows a top view of the second embodiment of a coupling portion 20. A diameter 34 of an outer periphery of the cavity 22 may be adapted and sized to accommodate different sized vial caps. As described herein above, the diameter 34 is preferably slightly larger than a diameter of a corresponding cap diameter. In this way, the cap does not stick inside the cavity 22 requiring a user to manually remove the cap from the coupling portion 20.

FIG. 14 shows a side view of the second embodiment of the coupling portion 20. FIG. 15 shows a cross-sectional view of the coupling portion 20 along line D-D as shown in FIG. 14. As FIG. 15 shows, the second embodiment of the coupling portion 20 includes a coupling means 32 configured to engage the coupling means 30 of the severable body 18, similar to the coupling portion 20 shown in FIGS. 9-12. As above, the coupling means 32 preferably includes a plurality of helically-shaped threads and grooves on an inner surface configured to couple to an outer surface of a shaft portion such as the severable body 18, wherein the threads and grooves of the coupling means 32 are sized and adapted to mesh or couple to corresponding threads and grooves of the coupling means 30. The space between the flanges 19 open into the cavity 22 of the coupling portion 20. The cavity 22 is preferably circular-shaped, but may be sized and adapted to receive a particular size cap 12.

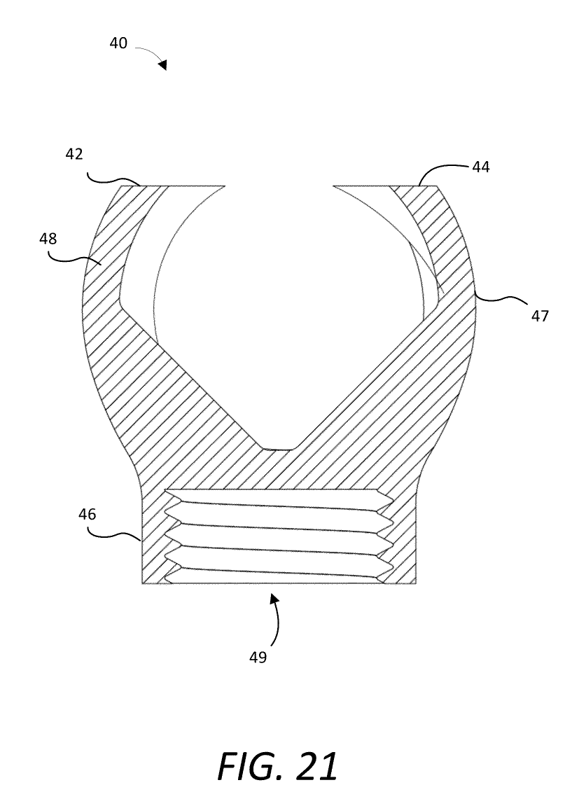

FIGS. 17-20 show a de-capper attachment tool 40 configured to selectively couple to the severable body 18 described herein above and shown in FIGS. 7 and 8. The de-capper attachment tool 40 is configured to remove a cap from a vial such as the vial 14 shown in FIG. 1. The tool 40 is formed of a first and second member 42 and 44, respectively, and a base 46. The first and second members 42 and 44 are preferably convexly curved outwardly. In one embodiment the tool 40 is integrally formed. The second member 44 includes a concave-shaped end configured to provide a lifting force from a user onto a cap. The first member 42 includes a convex-shaped end configured to provide a downward force on an opposite end of a vial cap. In this way, a user may use the tool as a lever force upon the vial cap, wherein the effort from a user is concurrently communicated to the vial cap as an upward force to a first end and a downward force to a second end. In one embodiment, the first and second members 42 and 44 have straight ends.

FIG. 21 shows a cross-sectional view of the de-capper attachment tool 40. As FIG. 21 shows, the de-capper attachment tool 40 includes a coupling means 49 configured to engage the coupling means 30 of the severable body 18. The coupling means 49 preferably includes a plurality of helically-shaped threads and grooves on an inner surface configured to couple to an outer surface of a shaft portion such as the severable body 18, wherein the threads and grooves of the coupling means 49 are sized and adapted to mesh or couple to corresponding threads and grooves of the coupling means 30.

According to an exemplary embodiment of the present disclosure, in operation, the second member 44 of the tool 40 is slid between a cap and vial by a user. The first member 42 is pressed upon a top surface of the cap. The user exerts a rocking motion with the apparatus creating a lever force that simultaneously exerts a lifting force on a first side of the cap and a depression force on a second side of the cap, removing the cap from the vial. For embodiments of a vial having a snap cap, where the snap cap covers outer edges of the vial, the second member 44 is placed between the snap cap and an outer surface of the vial. The user may then use the apparatus 10 to lift the snap cap upward and over opening of the vial.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A hand-held apparatus, comprising:
a rigid body, the body sized and adapted for gripping by a user; and
a coupling portion comprising an axially recessed portion, the recessed portion forming a bottom surface and an interior axial surface, a plurality of flanges longitudinally arranged and radially extended from the interior axial surface toward a center region of the recessed portion.

2. The apparatus of claim 1, wherein the plurality of flanges are further arranged circumferentially around the interior axial surface.

3. The apparatus of claim 2, further comprising: forming a circular void space defined by a circumferential periphery of the plurality of flanges, the circumferential periphery defined by a diameter associated with end portions of the flanges.

4. The apparatus of claim 1, wherein the plurality of flanges are tapered at an engagement end.

5. The apparatus of claim 1, wherein the plurality of flanges are flexible and configured to flexibly engage a cap.

6. The apparatus of claim 1, wherein the bottom surface is substantially flat and configured to engage a top surface of a vial cap.

7. The apparatus of claim 1, wherein the rigid body is cylindrically-shaped and further comprises a vase-shaped end having a top surface configured to receive a user's thumb.

8. The apparatus of claim 1, wherein the hand-held apparatus is integrally formed into a contiguous structure.

9. The apparatus of claim 1, wherein the coupling portion is selectively removable from the body.

10. The apparatus of claim 9, wherein the body further comprises a mechanical screw portion formed at one end configured to rotatably engage one or more helically-shaped threads and grooves of the coupling portion.

11. A hand-held vial cap system, comprising:
a rigid body having a mechanical screw portion at one end and a second end vase-shaped comprising a top surface configured to receive a user's thumb;
a selectively removable coupling portion comprising an axially recessed portion, the recessed portion forming a bottom surface and an interior axial surface, a plurality of flanges longitudinally arranged and radially extended from the interior axial surface toward a center region of the recessed portion; and
a selectively removable de-coupling portion configured to selectively remove vial caps from a vial.

12. The system of claim 11, wherein the mechanical screw portion is configured to rotatably engage one or more helically-shaped threads and grooves of the coupling portion and the de-coupling portion.

13. The system of claim 11, wherein the de-coupling portion comprises a first member having a convex-shaped end and configured to communicate a downward force upon a vial cap and a second member having a concave-shaped end configured to communicate an upward force onto a vial cap.

14. The system of claim 11, wherein the de-coupling portion is configured to remove a vial cap from a vial by use of lever forces.

15. A hand-held apparatus, comprising:
a rigid body having a mechanical screw portion at one end, the body sized and adapted for gripping by a user;
a de-coupling portion comprising:
one or more helically-shaped threads and grooves configured to rotatably engage the mechanical screw portion of the body,
a first member having a convex-shaped end, and
a second member having a concave-shaped end; and
wherein the de-coupling portion is configured to selectively remove vial caps from a vial using physical lever forces communicated from a user.

16. The apparatus of claim 15, wherein the first and second members are convexly curved outwardly.

17. The apparatus of claim 15, wherein the convex-shaped end of the first member is configured to communicate a downward force upon a vial cap.

18. The apparatus of claim 15, wherein the concave-shaped end of the second member is configured to communicate an upward force onto a vial cap.

19. The apparatus of claim 15, wherein the de-coupling portion further comprises a base portion, the base portion having an axially recessed portion comprising the one or more helically-shaped threads and grooves on an axial surface thereof.

20. The apparatus of claim 15, wherein the mechanical screw portion comprises one or more helical male threads and grooves and wherein one or more helically-shaped threads and grooves of the de-coupling portion are one or more helical female threads and grooves.
